(19) United States
(12) Patent Application Publication
(10) Pub. No.: US 2026/0299779 A1
(43) Pub. Date: Oct. 1, 2026

(54) IN-FIELD DOWNLOAD OF DATA TO A MEMORY DEVICE

(71) Applicant: Micron Technology, Inc., Boise, ID (US)

(72) Inventors: Alex Sheng-Huang Lee, Meridian, ID (US); Edric Goh, Singapore (SG); Satoru Tamada, Singapore (SG); Dheeraj Srinivasan, San Jose, CA (US)

(21) Appl. No.: 19/629,695

(22) Filed: Mar. 26, 2026

Related U.S. Application Data
(60) Provisional application No. 63/781,694, filed on Apr. 1, 2025.

(51) Int. Cl. G06F 3/06

(52) U.S. Cl. CPC G06F 3/0607; G06F 3/0632; G06F 3/0659; G06F 3/0673

(57) ABSTRACT

A memory device with a programmable read only memory (ROM) block, a volatile memory location, and control logic configured to cause a transfer of update data stored in a portion of the programmable ROM to the volatile memory location, where the update data is received from a source when the memory device is operating in an in-field environment.

### TECHNICAL FIELD

This application claims priority to U.S. Provisional Patent Application No. 63/781,694, filed Apr. 1, 2025, titled “In-Field Download of Data to a Memory Device,” which is incorporated herein by reference in its entirety.

### TECHNICAL FIELD

Embodiments of the disclosure relate generally to memory sub-systems, and more specifically, relate to the in-field download of data to a memory device.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1A illustrates an example computing system that includes a memory sub-system, in accordance with one or more embodiments of the present disclosure.

FIG. 1B is a block diagram of a memory device in communication with a memory sub-system controller of a memory sub-system, in accordance with one or more embodiments of the present disclosure.

FIG. 2A-2D are schematics of portions of an array of memory cells as could be used in a memory of the type described with reference to FIG. 1B, in accordance with one or more embodiments of the present disclosure.

FIG. 3 is a block schematic of a portion of an array of memory cells as could be used in a memory of the type described with reference to FIG. 1B, in accordance with one or more embodiments of the present disclosure.

FIG. 4 illustrates an example memory sub-system including a download manager configured to manage the downloading of data to an in-field memory device, in accordance with one or more embodiments of the present disclosure.

FIG. 5 illustrates an example memory device including a target volatile memory location configured to store update data downloaded during in-field operation of the memory device, according to embodiments of the present disclosure.

FIG. 6 illustrates an example process for downloading a first type of trim data to a target location of an in-field memory device, according to embodiments of the present disclosure.

FIG. 7 illustrates an example process for downloading a second type of trim data to a target location of an in-field memory device, according to embodiments of the present disclosure.

FIG. 8 illustrates an example process for downloading firmware update data to a target location of an in-field memory device, according to embodiments of the present disclosure.

FIG. 9 is a flow diagram of an example multi-stage downloading of data to an in-field memory device, in accordance with one or more embodiments of the present disclosure.

FIG. 10 is a block diagram of an example computer system in which embodiments of the present disclosure can operate.

### DETAILED DESCRIPTION

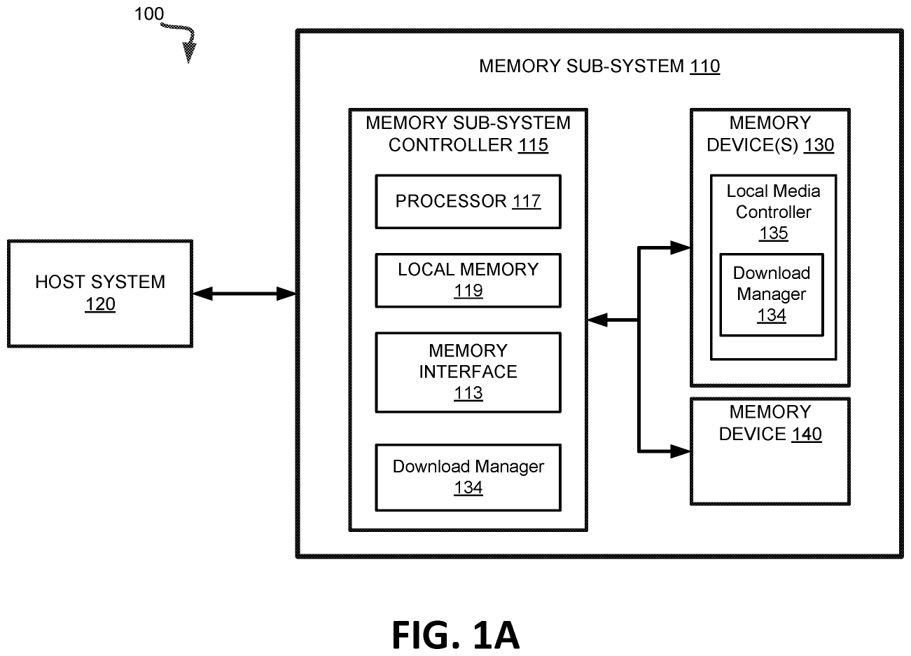

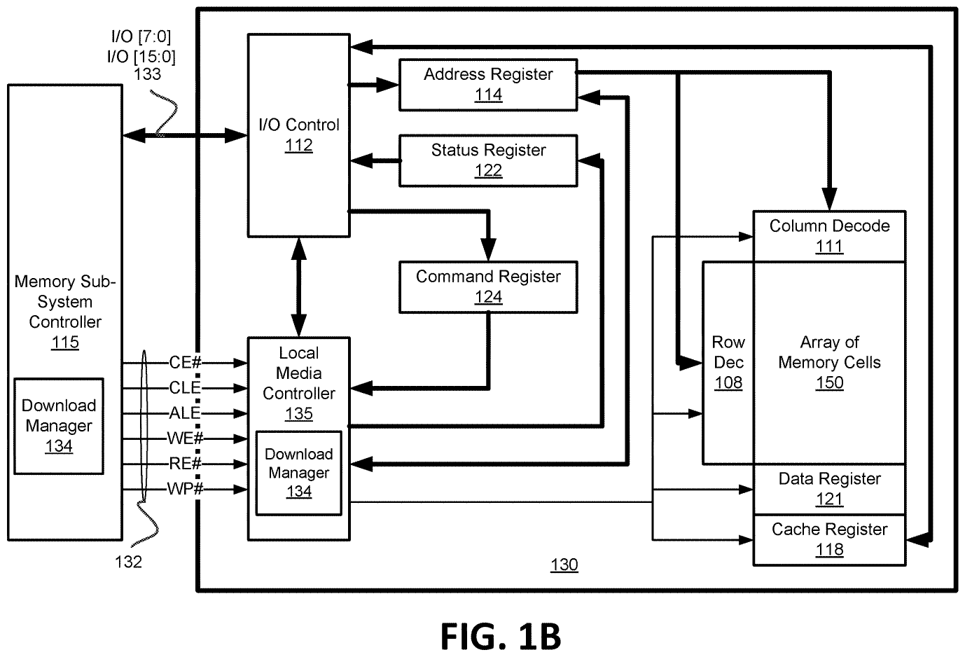

Aspects of the present disclosure are directed to control logic of a memory device that is configured to enable the in-field (i.e., during runtime of the memory device) downloading of data (e.g., trim data updates, firmware code updates, etc.). A memory sub-system can be a storage device, a memory module, or a hybrid of a storage device and memory module. Examples of storage devices and memory modules are described below in conjunction with FIG. 1A. In general, a host system can utilize a memory sub-system that includes one or more components, such as memory devices that store data. The host system can provide data to be stored at the memory sub-system and can request data to be retrieved from the memory sub-system.

The memory sub-system can include multiple memory components or memory devices that can store data from the host system, to include a programmable memory device. A memory device can include a programmable read-only memory (ROM) separate from programmable memory (e.g., memory array) of a memory device. The ROM stores instructions (e.g., microcode) for the programmable memory of the memory device. These instructions can be adapted to respond to commands (e.g., from a host system) and perform operations according to logic such as a state machine or the like.

The memory sub-system can include multiple memory components or memory devices that can store data from the host system, to include a programmable memory device. A memory device can include a ROM separate from programmable memory (e.g., memory array) of a memory device. The ROM stores instructions (e.g., microcode) for the programmable memory of the memory device. These instructions can be adapted to respond to commands (e.g., from a host system) and perform operations according to logic such as a state machine or the like. A ROM-emulated memory (REM) of a memory device includes data that can be stored into reserved pages of the memory array as a patch, e.g., an update to operation of the instructions stored in the ROM. In this way, although the ROM is read only, the operation of the ROM can be altered or fixed later on after the memory device has shipped to a customer.

For example, during a manufacturing phase, data (e.g., trim values, firmware, etc.) relating to the in-field (or user mode) operation of the memory device may be loaded and stored on the memory device. However, once the memory device is deployed in-field and operating in a user mode environment, providing updates to this data (e.g., trim value updates, firmware updates) is challenging and inefficient. In particular, after shipping the memory device, any updates to the memory device (e.g., updated trim data, firmware updates, etc.) are made via the memory sub-system controller domain or operating system domain, and not the memory domain.

Aspects of the present disclosure are directed to a multi-stage process for downloading update data (e.g., trim update data, firmware update data, etc.) to an in-field memory device of a memory sub-system. According to embodiments, the download manager uses a ROM-emulated memory (REM) of the memory device to enable the in-field download and implementation of trim updates and firmware updates (also referred to as REM update data). According to embodiments, the download manager enables the download of multiple firmware versions corresponding to different use cases.

According to embodiments, during a first stage of the multi-stage process, update data (e.g., trim update data, REM update data, or both) is received from a data source (e.g., a memory device vendor) and programmed to a programmable ROM of the memory device in a runtime or user mode environment. For example, a vendor of the memory device may utilize the multi-stage process to perform updates to the ROM either to fix operation of the ROM or to install a debug patch for diagnostic purposes, after the memory device is in operation in the field (i.e., in the user mode environment).

According to embodiments, during a second stage of the multi-stage process, the update data programmed to the programmable ROM is transferred and stored in a target storage location (e.g., a target volatile memory (VM) location such as a static random access memory (SRAM)) of the memory device. The target storage location (also referred to as a “target VM location” or “SRAM”) may be used to store the update data to enable multiple versions of memory device firmware based on use cases, with optimized allocations of the target VM location for storage of firmware or REM codes. Advantageously, the programming of the update data to the programmable ROM of the memory device in the user mode environment may be performed without requiring test mode access or complex routines (e.g., manual trim override routines, complicated command sequences, etc.). Furthermore, the in-field download of update data and safe activation of test mode codes for in-field diagnostics and debugging (e.g., downloading of a diagnostic or debug patch) may performed without revealing corresponding source code. In addition, in-field programming of an allocated portion of the programmable ROM is enabled, without requiring the erasure of the entire programmable ROM block and the re-programming of erased data (e.g., trims, repairs, various imprint data, etc.). These advantages will be discussed in more detail. Other advantages will be apparent to those skilled in the art of power disable features of a memory sub-system discussed hereinafter.

FIG. 1A illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1A illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, compute express link (CXL) interface). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a CXL interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1A illustrates a memory sub-system 110 as an example. In general, the host system 120 can access multiple memory sub-systems via a same communication connection, multiple separate communication connections, and/or a combination of communication connections.

The memory devices 130,140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include negative-AND (NAND) type flash memory and write-in-place memory, such as a three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks. In one embodiment, the term “MLC memory” can be used to represent any type of memory cell that stores more than one bit per cell (e.g., 2 bits, 3 bits, 4 bits, or 5 bits per cell).

Although non-volatile memory components such as 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-OR (NOR) flash memory, and electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can be a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1A has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which includes a raw memory device 130 having control logic (e.g., local media controller 135) on the die and a controller (e.g., memory sub-system controller 115) for media management within the same memory device package. An example of a managed memory device is a managed NAND (MNAND) device.

In one embodiment, the memory sub-system 110 includes a memory interface component 113. Memory interface component 113 is responsible for handling interactions of memory sub-system controller 115 with the memory devices of memory sub-system 110, such as memory device 130. For example, memory interface component 113 can send memory access commands corresponding to requests received from host system 120 to memory device 130, such as program commands, read commands, or other commands. In addition, memory interface component 113 can receive data from memory device 130, such as data retrieved in response to a read command or a confirmation that a program command was successfully performed. For example, the memory sub-system controller 115 can include a processor 117 (processing device) configured to execute instructions stored in local memory 119 for performing the operations described herein.

In one embodiment, memory device 130 includes a download manager 134 configured to manage the in-field download of data (e.g., trim update data and firmware update data) from a data source (e.g., a memory device vendor), according to embodiments of the present disclosure. Further details with regards to the operations of download manager 134 are described below.

FIG. 1B is a simplified block diagram of a first apparatus, in the form of a memory device 130, in communication with a second apparatus, in the form of a memory sub-system controller 115 of a memory sub-system (e.g., memory sub-system 110 of FIG. 1A), according to an embodiment. Some examples of electronic systems include personal computers, personal digital assistants (PDAs), digital cameras, digital media players, digital recorders, games, appliances, vehicles, wireless devices, mobile telephones and the like. The memory sub-system controller 115 (e.g., a controller external to the memory device 130), may be a memory controller or other external host device.

Memory device 130 includes an array of memory cells 150 logically arranged in rows and columns. Memory cells of a logical row are typically connected to the same access line (e.g., a wordline) while memory cells of a logical column are typically selectively connected to the same data line (e.g., a bitline). A single access line may be associated with more than one logical row of memory cells and a single data line may be associated with more than one logical column. Memory cells (not shown in FIG. 1B) of at least a portion of array of memory cells 150 are capable of being programmed to one of at least two target data states.

Row decode circuitry 108 and column decode circuitry 111 are provided to decode address signals. Address signals are received and decoded to access the array of memory cells 150. Memory device 130 also includes input/output (I/O) control circuitry 112 to manage input of commands, addresses and data to the memory device 130 as well as output of data and status information from the memory device 130. An address register 114 is in communication with I/O control circuitry 112 and row decode circuitry 108 and column decode circuitry 111 to latch the address signals prior to decoding. A command register 124 is in communication with I/O control circuitry 112 and local media controller 135 to latch incoming commands.

A controller (e.g., the local media controller 135 internal to the memory device 130) controls access to the array of memory cells 150 in response to the commands and generates status information for the external memory sub-system controller 115, i.e., the local media controller 135 is configured to perform access operations (e.g., read operations, programming operations and/or erase operations) on the array of memory cells 150. The local media controller 135 is in communication with row decode circuitry 108 and column decode circuitry 111 to control the row decode circuitry 108 and column decode circuitry 111 in response to the addresses. In one embodiment, local media controller 135 includes download manager 134, which can cause execution of ganged memory access operations (i.e., memory access operations associated with multiple selected pages using a set of multiple sense modules coupled to a page buffer circuit via a global bitline, where each sense module is coupled to a sub-set of multiple pillars, as described herein.

The local media controller 135 is also in communication with a cache register 118. Cache register 118 latches data, either incoming or outgoing, as directed by the local media controller 135 to temporarily store data while the array of memory cells 150 is busy writing or reading, respectively, other data. During a program operation (e.g., write operation), data may be passed from the cache register 118 to a data register (or page buffer circuit) 121 for transfer to the array of memory cells 150; then new data may be latched in the cache register 118 from the I/O control circuitry 112. During a read operation, data may be passed from the cache register 118 to the I/O control circuitry 112 for output to the memory sub-system controller 115; then new data may be passed from the page buffer circuit 121 to the cache register 118. The cache register 118 and/or the page buffer circuit 121 may form (e.g., may form a portion of) a page buffer of the memory device 130. The page buffer circuit 121 may further include sensing devices (not shown in FIG. 1B) to sense a data state of a memory cell of the array of memory cells 150, e.g., by sensing a state of a data line connected to that memory cell. A status register 122 may be in communication with I/O control circuitry 112 and the local memory controller 135 to latch the status information for output to the memory sub-system controller 115.

Memory device 130 receives control signals at the memory sub-system controller 115 from the local media controller 135 over a control link 132. For example, the control signals can include a chip enable signal CE #, a command latch enable signal CLE, an address latch enable signal ALE, a write enable signal WE #, a read enable signal RE #, and a write protect signal WP #. Additional or alternative control signals (not shown) may be further received over control link 132 depending upon the nature of the memory device 130. In one embodiment, memory device 130 receives command signals (which represent commands), address signals (which represent addresses), and data signals (which represent data) from the memory sub-system controller 115 over a multiplexed input/output (I/O) bus 133 and outputs data to the memory sub-system controller 115 over I/O bus 133.

For example, the commands may be received over input/output (I/O) pins [7:0] of I/O bus 133 at I/O control circuitry 112 and may then be written into command register 124. The addresses may be received over input/output (I/O) pins [7:0] of I/O bus 133 at I/O control circuitry 112 and may then be written into address register 114. The data may be received over input/output (I/O) pins [7:0] for an 8-bit device or input/output (I/O) pins [15:0] for a 16-bit device at I/O control circuitry 112 and then may be written into cache register 118. The data may be subsequently written into page buffer circuit 121 for programming the array of memory cells 150.

In an embodiment, cache register 118 may be omitted, and the data may be written directly into page buffer circuit 121. Data may also be output over input/output (I/O) pins [7:0] for an 8-bit device or input/output (I/O) pins [15:0] for a 16-bit device. Although reference may be made to I/O pins, they may include any conductive node providing for electrical connection to the memory device 130 by an external device (e.g., the memory sub-system controller 115), such as conductive pads or conductive bumps as are commonly used.

It will be appreciated by those skilled in the art that additional circuitry and signals can be provided, and that the memory device 130 of FIG. 1B has been simplified. It should be recognized that the functionality of the various block components described with reference to FIG. 1B may not necessarily be segregated to distinct components or component portions of an integrated circuit device. For example, a single component or component portion of an integrated circuit device could be adapted to perform the functionality of more than one block component of FIG. 1B. Alternatively, one or more components or component portions of an integrated circuit device could be combined to perform the functionality of a single block component of FIG. 1B. Additionally, while specific I/O pins are described in accordance with popular conventions for receipt and output of the various signals, it is noted that other combinations or numbers of I/O pins (or other I/O node structures) may be used in the various embodiments.

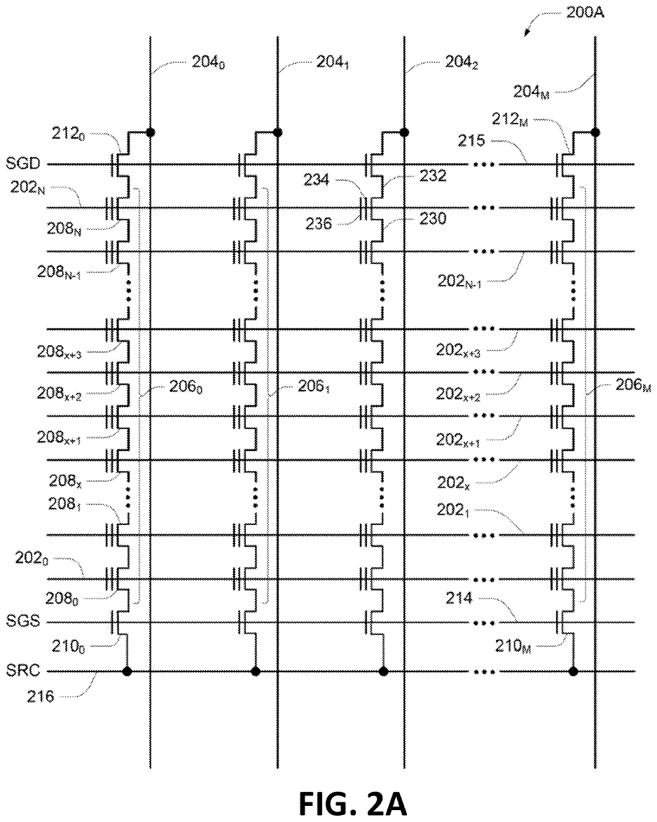

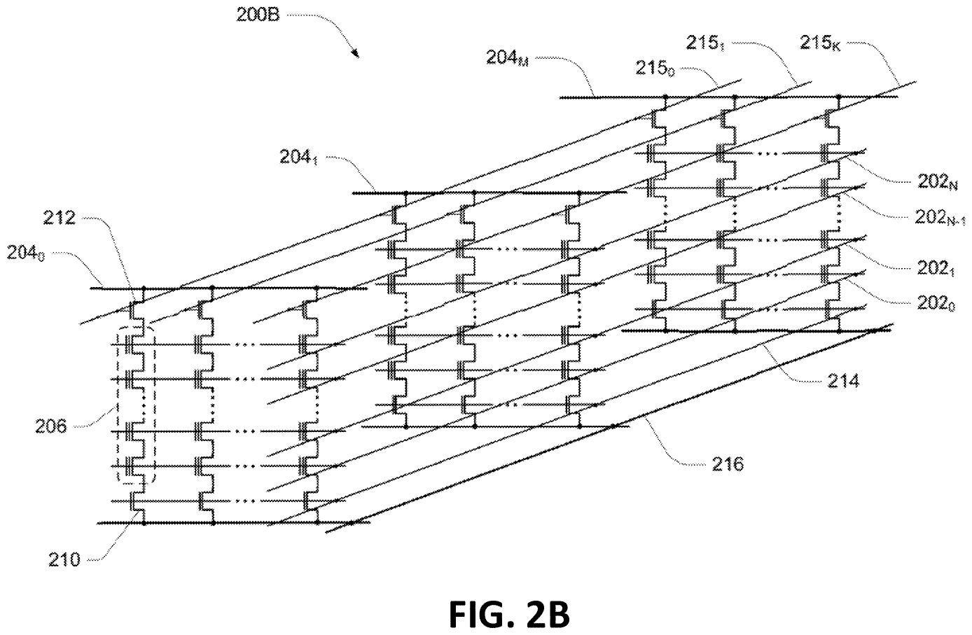

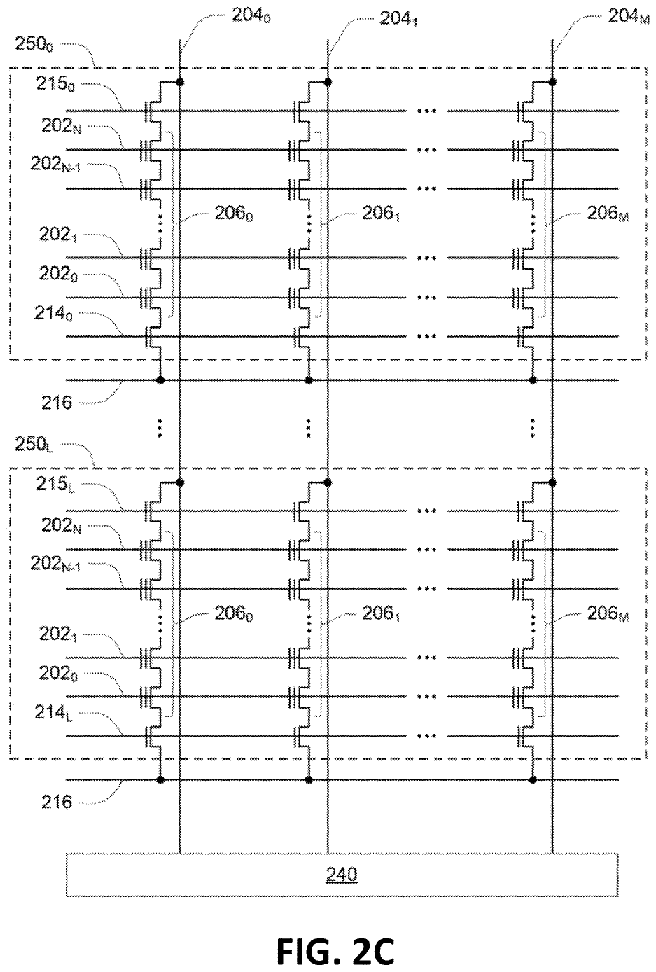

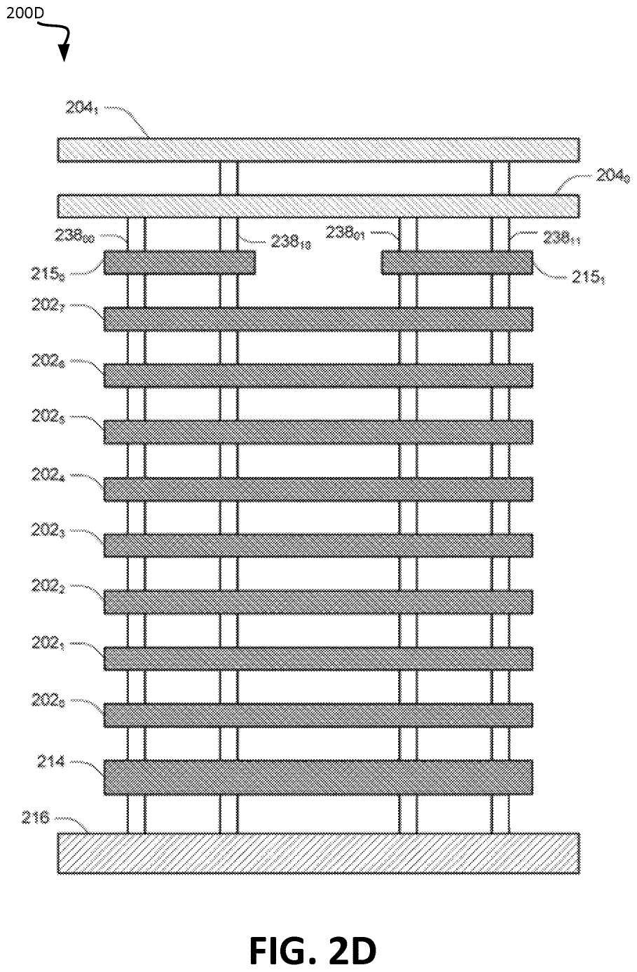

FIG. 2A-2C are schematics of portions of an array of memory cells 200A, such as a NAND memory array, as could be used in a memory of the type described with reference to FIG. 1B according to an embodiment, e.g., as a portion of the array of memory cells 104. Memory array 200A includes access lines, such as wordlines 202₀ to 202_{N}, and data lines, such as bitlines 204₀ to 204_{M}. The wordlines 202 can be connected to global access lines (e.g., global wordlines), not shown in FIG. 2A, in a many-to-one relationship. For some embodiments, memory array 200A can be formed over a semiconductor that, for example, can be conductively doped to have a conductivity type, such as a p-type conductivity, e.g., to form a p-well, or an n-type conductivity, e.g., to form an n-well.

Memory array 200A can be arranged in rows (each corresponding to a wordline 202) and columns (each corresponding to a bitline 204). Each column can include a string of series-connected memory cells (e.g., non-volatile memory cells), such as one of NAND strings 206₀ to 206_{M}. Each NAND string 206 can be connected (e.g., selectively connected) to a common source (SRC) 216 and can include memory cells 208₀ to 208_{N}. The memory cells 208 can represent non-volatile memory cells for storage of data. The memory cells 208 of each NAND string 206 can be connected in series between a select gate 210 (e.g., a field-effect transistor), such as one of the select gates 210₀ to 210_{M} (e.g., that can be source select transistors, commonly referred to as select gate source), and a select gate 212 (e.g., a field-effect transistor), such as one of the select gates 212₀ to 212_{M} (e.g., that can be drain select transistors, commonly referred to as select gate drain). Select gates 210₀ to 210_{M} can be commonly connected to a select line 214, such as a source select line (SGS), and select gates 212₀ to 212_{M} can be commonly connected to a select line 215, such as a drain select line (SGD). Although depicted as traditional field-effect transistors, the select gates 210 and 212 can utilize a structure similar to (e.g., the same as) the memory cells 208. The select gates 210 and 212 can represent a number of select gates connected in series, with each select gate in series configured to receive a same or independent control signal.

A source of each select gate 210 can be connected to common source 216. The drain of each select gate 210 can be connected to a memory cell 208₀ of the corresponding NAND string 206. For example, the drain of select gate 210₀ can be connected to memory cell 208₀ of the corresponding NAND string 206₀. Therefore, each select gate 210 can be configured to selectively connect a corresponding NAND string 206 to the common source 216. A control gate of each select gate 210 can be connected to the select line 214.

The drain of each select gate 212 can be connected to the bitline 204 for the corresponding NAND string 206. For example, the drain of select gate 212₀ can be connected to the bitline 204₀ for the corresponding NAND string 206₀. The source of each select gate 212 can be connected to a memory cell 208_{N} of the corresponding NAND string 206. For example, the source of select gate 212₀ can be connected to memory cell 208_{N} of the corresponding NAND string 206₀. Therefore, each select gate 212 can be configured to selectively connect a corresponding NAND string 206 to the corresponding bitline 204. A control gate of each select gate 212 can be connected to select line 215.

The memory array 200A in FIG. 2A can be a quasi-two-dimensional memory array and can have a generally planar structure, e.g., where the common source 216, NAND strings 206 and bitlines 204 extend in substantially parallel planes. Alternatively, the memory array 200A in FIG. 2A can be a three-dimensional memory array, e.g., where NAND strings 206 can extend substantially perpendicular to a plane containing the common source 216 and to a plane containing the bitlines 204 that can be substantially parallel to the plane containing the common source 216.

Typical construction of memory cells 208 includes a data-storage structure 234 (e.g., a floating gate, charge trap, and the like) that can determine a data state of the memory cell (e.g., through changes in threshold voltage), and a control gate 236, as shown in FIG. 2A. The data-storage structure 234 can include both conductive and dielectric structures while the control gate 236 is generally formed of one or more conductive materials. In some cases, memory cells 208 can further have a defined source/drain (e.g., source) 230 and a defined source/drain (e.g., drain) 232. The memory cells 208 have their control gates 236 connected to (and in some cases form) a wordline 202.

A column of the memory cells 208 can be a NAND string 206 or a number of NAND strings 206 selectively connected to a given bitline 204. A row of the memory cells 208 can be memory cells 208 commonly connected to a given wordline 202. A row of memory cells 208 can, but need not, include all the memory cells 208 commonly connected to a given wordline 202. Rows of the memory cells 208 can often be divided into one or more groups of physical pages of memory cells 208, and physical pages of the memory cells 208 often include every other memory cell 208 commonly connected to a given wordline 202. For example, the memory cells 208 commonly connected to wordline 202_{N} and selectively connected to even bitlines 204 (e.g., bitlines 204₀, 204₂, 204₄, etc.) can be one physical page of the memory cells 208 (e.g., even memory cells) while memory cells 208 commonly connected to wordline 202_{N} and selectively connected to odd bitlines 204 (e.g., bitlines 204₁, 204₃, 204₅, etc.) can be another physical page of the memory cells 208 (e.g., odd memory cells).

Although bitlines 204₃-204₅ are not explicitly depicted in FIG. 2A, it is apparent from the figure that the bitlines 204 of the array of memory cells 200A can be numbered consecutively from bitline 204₀ to bitline 204_{M}. Other groupings of the memory cells 208 commonly connected to a given wordline 202 can also define a physical page of memory cells 208. For certain memory devices, all memory cells commonly connected to a given wordline can be deemed a physical page of memory cells. The portion of a physical page of memory cells (which, in some embodiments, could still be the entire row) that is read during a single read operation or programmed during a single programming operation (e.g., an upper or lower page of memory cells) can be deemed a logical page of memory cells. A block of memory cells can include those memory cells that are configured to be erased together, such as all memory cells connected to wordlines 202₀-202_{N} (e.g., all NAND strings 206 sharing common wordlines 202). Unless expressly distinguished, a reference to a page of memory cells herein refers to the memory cells of a logical page of memory cells. Although the example of FIG. 2A is discussed in conjunction with NAND flash, the embodiments and concepts described herein are not limited to a particular array architecture or structure, and can include other structures (e.g., SONOS, phase change, ferroelectric, etc.) and other architectures (e.g., AND arrays, NOR arrays, etc.).

FIG. 2B is another schematic of a portion of an array of memory cells 200B as could be used in a memory of the type described with reference to FIG. 1B, e.g., as a portion of the array of memory cells 104. Like numbered elements in FIG. 2B correspond to the description as provided with respect to FIG. 2A. FIG. 2B provides additional detail of one example of a three-dimensional NAND memory array structure. The three-dimensional NAND memory array 200B can incorporate vertical structures which can include semiconductor pillars where a portion of a pillar can act as a channel region of the memory cells of NAND strings 206. The NAND strings 206 can be each selectively connected to a bitline 204₀-204_{M} by a select transistor 212 (e.g., that can be drain select transistors, commonly referred to as select gate drain) and to a common source 216 by a select transistor 210 (e.g., that can be source select transistors, commonly referred to as select gate source). Multiple NAND strings 206 can be selectively connected to the same bitline 204. Subsets of NAND strings 206 can be connected to their respective bitlines 204 by biasing the select lines 215₀-215_{K} to selectively activate particular select transistors 212 each between a NAND string 206 and a bitline 204. The select transistors 210 can be activated by biasing the select line 214. Each wordline 202 can be connected to multiple rows of memory cells of the memory array 200B. Rows of memory cells that are commonly connected to each other by a particular wordline 202 can collectively be referred to as tiers.

FIG. 2C is a further schematic of a portion of an array of memory cells 200C as could be used in a memory of the type described with reference to FIG. 1B, e.g., as a portion of the array of memory cells 104. Like numbered elements in FIG. 2C correspond to the description as provided with respect to FIG. 2A. The array of memory cells 200C can include strings of series-connected memory cells (e.g., NAND strings) 206, access (e.g., word) lines 202, data (e.g., bit) lines 204, select lines 214 (e.g., source select lines), select lines 215 (e.g., drain select lines) and a source 216 as depicted in FIG. 2A. A portion of the array of memory cells 200A can be a portion of the array of memory cells 200C, for example.

FIG. 2C depicts groupings of NAND strings 206 into blocks of memory cells 250, e.g., blocks of memory cells 250₀-250_{L}. Blocks of memory cells 250 can be groupings of memory cells 208 that can be erased together in a single erase operation, sometimes referred to as erase blocks. Each block of memory cells 250 can represent those NAND strings 206 commonly associated with a single select line 215, e.g., select line 215₀. The source 216 for the block of memory cells 250₀ can be a same source as the source 216 for the block of memory cells 250_{L}. For example, each block of memory cells 250₀-250_{L} can be commonly selectively connected to the source 216. Access lines 202 and select lines 214 and 215 of one block of memory cells 250 can have no direct connection to access lines 202 and select lines 214 and 215, respectively, of any other block of memory cells of the blocks of memory cells 250₀-250_{L}.

The bitlines 204₀-204_{M} can be connected (e.g., selectively connected) to a buffer portion 240, which can be a portion of the page buffer of the memory device 130. The buffer portion 240 can correspond to a memory plane (e.g., the set of blocks of memory cells 250₀-250_{L}). The buffer portion 240 can include sense circuits (which can include sense amplifiers) for sensing data values indicated on respective bitlines 204.

FIG. 2D is a diagram of a portion of an array of memory cells 200D (e.g., a portion of the array of memory cells 104). Channel regions (e.g., semiconductor pillars) 238₀₀ and 238₀₁ represent the channel regions of different strings of series-connected memory cells (e.g., strings 206 of FIGS. 2A-2C) selectively connected to the bitline 204₀. Similarly, channel regions 238₁₀ and 238₁₁ represent the channel regions of different strings of series-connected memory cells (e.g., NAND strings 206 of FIGS. 2A-2C) selectively connected to the bitline 204₁. A memory cell (not depicted in FIG. 2D) may be formed at each intersection of a wordline 202 and a channel region 238, and the memory cells corresponding to a single channel region 238 may collectively form a string of series-connected memory cells (e.g., a string 206 of FIGS. 2A-2C). Additional features might be common in such structures, such as dummy wordlines, segmented channel regions with interposed conductive regions, etc.

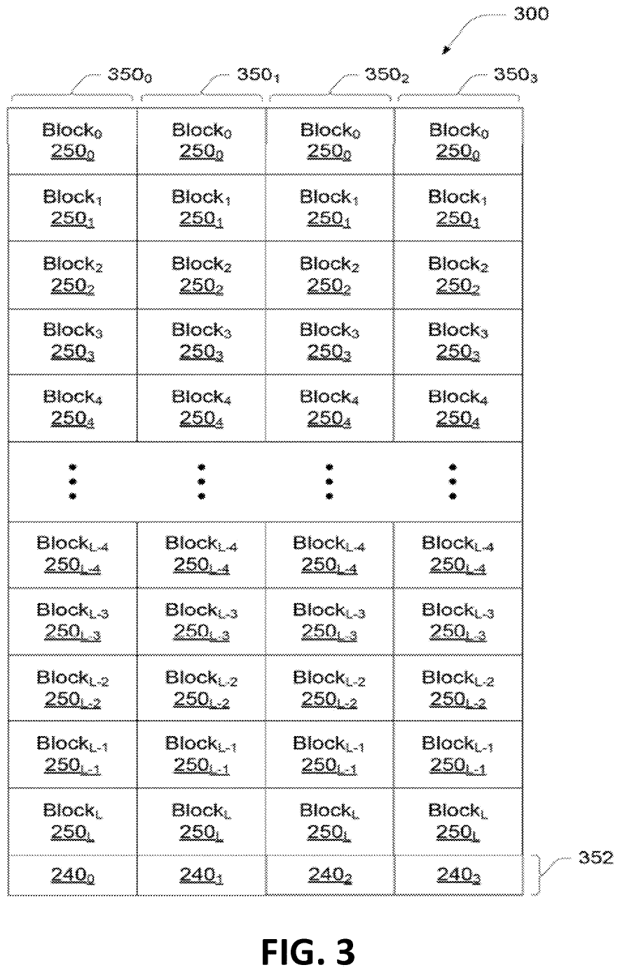

FIG. 3 is a block schematic of a portion of an array of memory cells 300 as could be used in a memory of the type described with reference to FIG. 1B. The array of memory cells 300 is depicted as having four memory planes 350 (e.g., memory planes 350₀-350₃), each in communication with a respective buffer portion 240, which can collectively form a page buffer 321. While four memory planes 350 are depicted, other numbers of memory planes 350 can be commonly in communication with a page buffer 352. Each memory plane 350 is depicted to include L+1 blocks of memory cells 250 (e.g., blocks of memory cells 250₀-250_{L}).

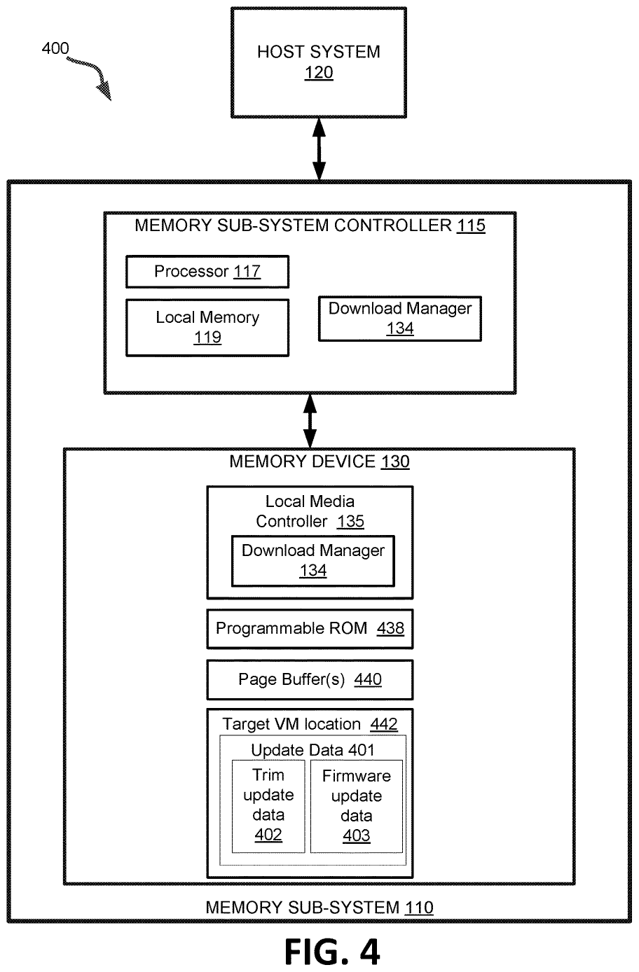

FIG. 4 illustrates an example memory sub-system 110 including a download manager 134 configured to manage the in-field (i.e., during user mode or runtime of memory device 130) download of update data (e.g., trim data updates, firmware code updates, etc.) 401. For example, the programmable memory device can be the memory device 130 discussed with reference to FIG. 1A. According to embodiments, the memory sub-system controller 115 includes logic (e.g., download manager 134) configured to manage the in-field download of the downloaded data (e.g., trim data updates, firmware code updates, fixed data representing the firmware, etc.) (also referred to as “REM data” or “REM update data”) received via an interface from a host system 120 (e.g., which received the trim data updates and REM data from an external source such as a memory device vendor). In an embodiment, the interface via which the trim data updates and REM data is received is a one-time programmable (OTP)-like in-field programming interface (herein referred to as an “in-field programming interface”). According to embodiments, the download manager 134 represents logic that can be part of the memory sub-system controller 115, the local media controller 135 of the memory device 130, or both. For example, the memory sub-system controller 115 can include the processor 117 (e.g., processing device) configured to execute instructions stored in local memory 119 to enable the download manager 134 to perform the operations described herein.

In various embodiments, the memory device 130 (such as negative-AND type flash memory (NAND) or other programmable non-volatile memory device) includes the local media controller 135 (e.g., control logic), a read-only memory (ROM) 438, page buffer(s) 440, and a static random access memory (SRAM) 442. In various embodiments, the SRAM 442 provides a storage location or buffer for storing the downloaded data 401, as described below.

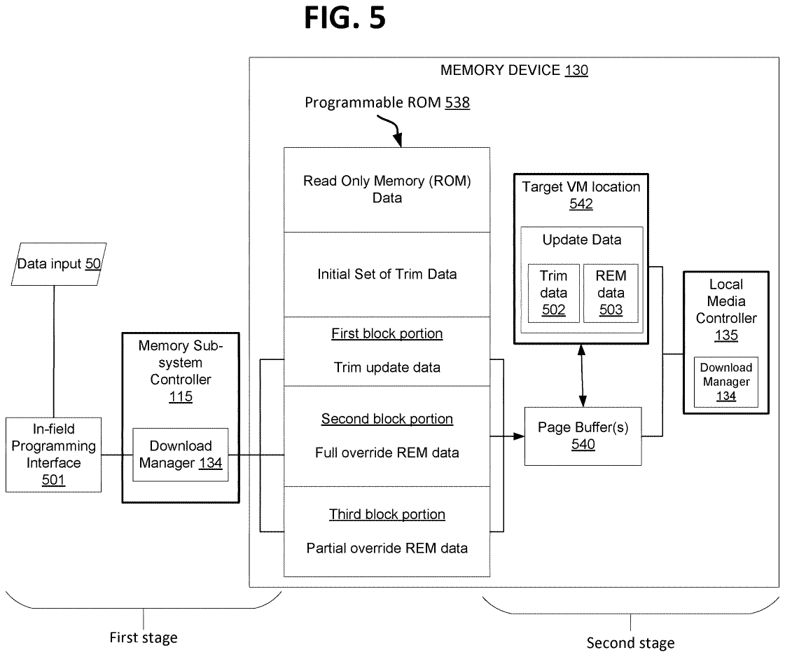

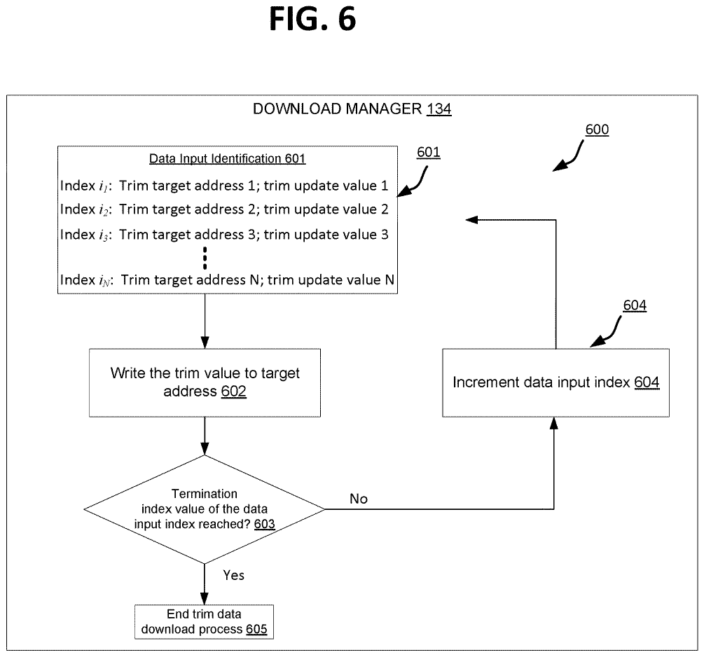

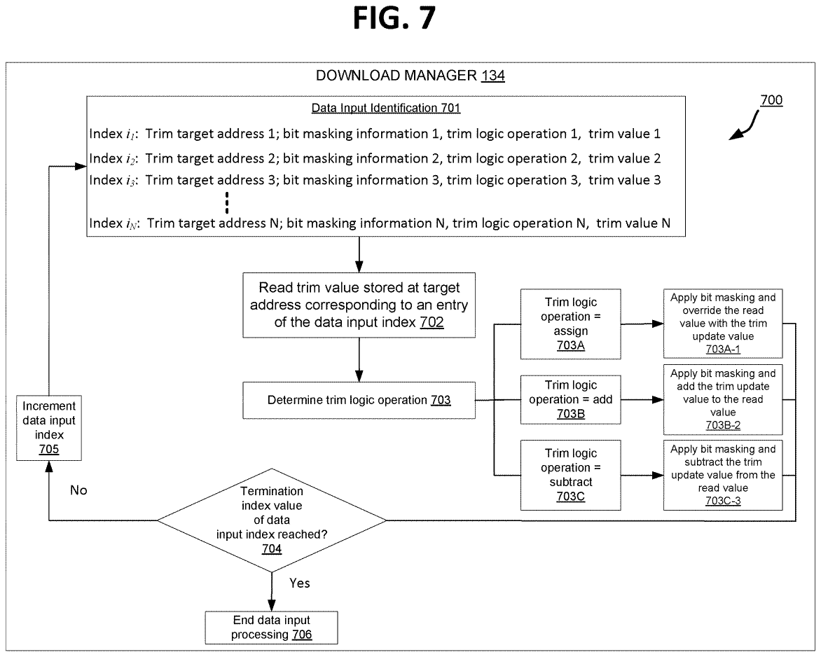

According to embodiments, the download manager 134 is configured to execute an in-field data download process including a first phase and a second phase. During the first phase, the download manager 134 receives a data input (i.e., trim data updates, REM data updates, etc.) from a data source (e.g., a user such as a memory device vendor) and programs the downloaded data to a programmable ROM block (programmable ROM 438) of the memory device 130, as described below in detail with reference to FIGS. 5-7. According to embodiments, the data input can be received from the host system 120, e.g., which received the data input (e.g., trim data update or REM data (or code) from a memory device vendor. In an embodiment, the data input can include one or more data packets having a first type of trim data updates including trim target address data and trim override value data, as described in greater detail below with reference to FIG. 6. In an example, the data input can include one or more data packets having a second type of trim data updates including trim target address data, trim bit masking data, trim logic operation data, and trim change value data, as described in greater detail below with reference to FIG. 7.

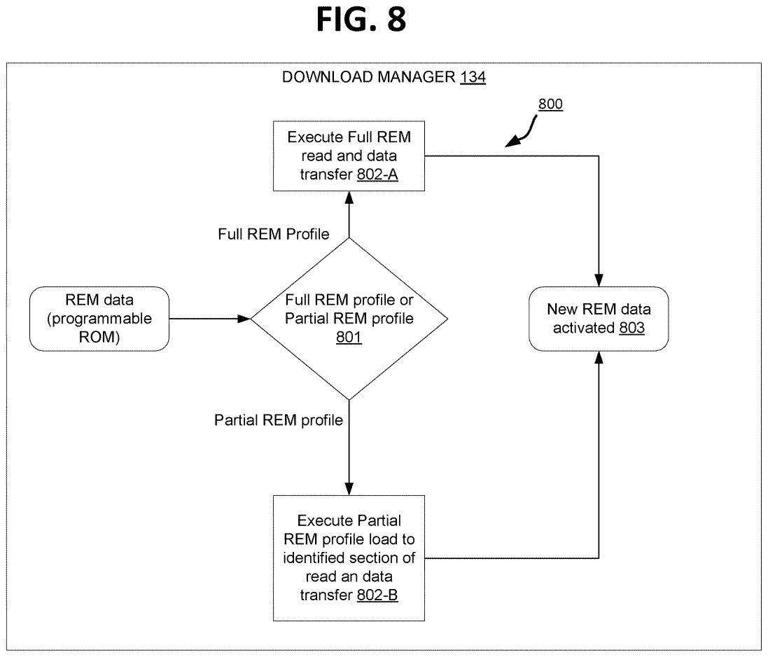

In an embodiment, the data input can include one or more data packets having a user-selectable REM data profile. For example, the user-selectable REM data profile may include a first profile having full REM data (e.g., firmware code corresponding to a full or complete update of the firmware associated with the memory device 130) or a second profile having partial REM data (e.g., firmware code corresponding to a partial update of the firmware associated with the memory device 130), as described in greater detail below with reference to FIGS. 5 and 8.

According to embodiments, during the first phase, the download manager 134 enables the download of trim updates and firmware updates (also referred to as REM update data) or firmware updates when the memory device 130 is in-field. In addition, the download manager 134 enables the download of multiple versions of the firmware (REM) data corresponding to multiple different use cases. According to embodiments, the download manager 134 programs the programmable ROM 438 with the data input, without requiring test mode access or the execution of complex routines (e.g., manual trim override routines, complicated command sequences, etc.).

According to embodiments, during the second stage of the in-field download process, the download manager 134 checks locations within the programmable ROM 438 to determine if trim update data or firmware update data is stored therein (e.g., stored data inputs resulting from the first stage of the in-field download process). In an embodiment, in response to determining that trim update data or firmware update data is stored in the programmable ROM 438 (downloaded data 401), the download manager 134 reads the downloaded data to one or more page buffers 140 and writes the corresponding update data 401 (e.g., to the target volatile memory (VM) location 442 (e.g., SRAM location) of the memory device 130.

FIG. 5 illustrates a download manager 134 configured to perform the multi-stage data download process to enable the in-field download of a data input 50 including one or more of trim update data and firmware (REM) update data associated with a memory device 130, according to embodiments of the present disclosure. As illustrated, during a first stage, the download manager 134 (e.g., logic executable by the memory sub-system controller 115) identifies the data input (data packets associated with trim update data and firmware (REM) update data (i.e., firmware update data)) provided by a user (e.g., a vendor associated with the memory device 130) via an in-field programming interface 501 (e.g., an OTP-like in-field programming interface). According to embodiments, during the first stage, a user invokes the in-field programming interface 501 to initiate the programming of the data input to the memory device 130. In an embodiment, the download manager 134 writes the data input to the programmable ROM 538 of the memory device 130. The programmable ROM 538 may include a first block portion allocated for storing trim update data, a second block portion allocated for storing firmware (REM) update data having a first profile (i.e., firmware code corresponding to a full or complete update of the firmware associated with the memory device 130), and a third block portion allocated for storing firmware update data having a second profile (i.e., firmware code corresponding to a partial update of the firmware associated with the memory device 130).

According to embodiments, during a second stage, the download manager 134 (e.g., logic executable by the local media controller 135 of the memory device 130) checks the first block portion, the second block portion, and the third block portion of the programmable ROM 538 to determine if downloaded data is present (i.e., the corresponding block portion is not erased or blank) and transfers or downloads the update data to a target data location (e.g., a target volatile memory (VM) location) 542 of the memory device 130. According to embodiments, the target VM location 542 includes a static read access memory (SRAM). According to embodiments, if a first type of trim data (e.g., trim override data) is identified in the first block portion, the download manager executes a first trim data download process during the second stage of the multi-stage data download process, as shown in FIG. 6. According to embodiments, if a second type of trim data (e.g., advanced override data) is identified in the first block portion, the download manager executes a second trim update data download process during the second stage of the multi-stage data download process, as shown in FIG. 7.

FIG. 6 illustrates an example of the first trim data download process 600 of the second stage of the multi-stage data download process, executed by a download manager 134 of a memory sub-system, to download a first type of trim data (also referred to as a first trim data download process) to the target VM location 542 of FIG. 5, according to an embodiment of the present disclosure. In an embodiment, the first trim data download process 600 includes the download of the first type of trim data which includes non-advanced trim override data. In an embodiment, the non-advanced trim override data includes an index associated with a data input, where each index value corresponds to a trim target address and a trim override value. According to embodiments, the first trim data download process 600 is executed by the download manager 134 at power up of the memory device (i.e., during an initialization stage of the memory device).

As shown in FIG. 6, in operation 601, the download manager 134 identifies a data input including an index (e.g., index 1, index 2, index 3 . . . index N) of trim update data (e.g., a first type of trim update data) to be downloaded and stored in a programmable ROM (e.g., stored in a first block portion of programmable ROM 538 of FIG. 5) of a memory device (e.g., memory device 130 of FIGS. 1A, 1B, 4, and 5), according to embodiments of the present disclosure. In the example shown in FIG. 6, the download manager 134 identifies the data input (e.g., received via an interface (e.g., in-field programming interface 501 of FIG. 5) associated with a memory sub-system) including an index having a set of one or more entries, where each index entry includes a trim target address and a trim update value.

In operation 602, for a first index entry value (i₁) in the index, the download manager 134 writes a trim update value (i.e., the trim override value) to the corresponding target address (i.e., the trim override value is written to the target VM location 542 of FIG. 5). In operation 603, the download manager 134 checks the index to determine if a termination value of the index (e.g., index value N in the example shown in FIG. 6) has been reached. If, in operation 603 the download manager 134 determines that a termination value of the index (i.e., a last entry in the index (e.g., i_{N})) has not been reached, the trim data download process proceeds to operation 604. In operation 604, the download manager 134 increments a counter associated with the data input index and returns to operation 601 to identify the next index value (e.g., i₂) and performs operation 602 to write the trim update value to the target address for the next index value. Operations 601, 602, 603, and 604 are repeated for each index value (e.g., index i₁ to index i_{N}) to write the trim data of the data input to a portion of the programmable ROM (e.g., the first block portion of the programmable ROM 538 of FIG. 5). According to embodiments, if the termination value is reached (e.g., i_{N}) in operation 603, the download process 600 proceeds to operation 605 and the trim data download process ends. According to embodiments, at the completion of the download process shown in FIG. 6, the trim update data stored in the programmable ROM (e.g., programmable ROM 538 of FIG. 5) to the target VM location (e.g., stored in the target VM location 542 as the trim data 502 of the downloaded data of FIG. 5) of the memory device.

FIG. 7 illustrates an example of the second trim data download process 700 of the second stage of the multi-stage data download process, executed by a download manager 134 of a memory sub-system, to download a second type of trim data to a target VM location (e.g., target VM location 542 of FIG. 5), according to an embodiment of the present disclosure. In an embodiment, the second trim data download process 700 includes the download of the second type of trim data which includes advanced trim override data. In an embodiment, the advanced trim override data includes an index associated with a data input, where each index value may include a trim target address, a trim bits masking value, a trim logical operation to be executed, and a trim change value.

As shown in FIG. 7, in operation 701, the download manager 134 identifies a data input including an index (e.g., index 1, index 2, index 3 . . . index N) of trim data (e.g., a first type of trim data) to be downloaded and stored in a programmable ROM (e.g., stored in a first block portion of programmable ROM 538 of FIG. 5) of a memory device (e.g., memory device 130 of FIGS. 1A, 1B, 4, and 5), according to embodiments of the present disclosure. In the example shown in FIG. 7, the download manager 134 identifies the data input (e.g., received via an interface (e.g., in-field programming interface 501 of FIG. 5) associated with a memory sub-system) including an index having a set of one or more entries, where each index entry includes a trim target address, bit masking information, trim logic operation (e.g., assign, add, subtract, etc.), and a trim update value.

In operation 702, the download manager 134 identifies the target trim address of the first index entry (i₁), reads a current trim value stored at the target address of the programmable ROM (also referred to as the “read trim value”) and buffers the read trim value (e.g., stores the read trim value in page buffer(s) 540 of FIG. 5). In operation 703, the download manager 134 determines a trim logic operation associated with the identified index entry. According to embodiments, example trim logic operations include an assign operation (e.g., an operation to assign or override the read trim value with the trim update value of the identified index entry (e.g., trim update value 1)), an add operation (e.g., an operation to add the trim update value of the index entry (e.g., trim value 1) to the read trim value), and a subtract operation (e.g., an operation to subtract the trim update value of the identified index entry (e.g., trim value 1) from the read trim value).

According to embodiments, if the trim logic operation is an assign operation 703A, the download manager 134 applies any bit masking information of the identified index entry (e.g., bit masking information 1 of index i₁) and overrides the read trim value with the trim update value of the identified index entry (e.g., trim value 1) in the target VM location of the memory device (e.g., target VM location 542 of FIG. 5).

According to embodiments, if the trim logic operation is an add operation 703B, the download manager 134 applies any bit masking information of the identified index entry (e.g., bit masking information 1 of index i1) and adds the trim update value to the read trim value in the target VM location of the memory device (e.g., target VM location 542 of FIG. 5).

According to embodiments, if the trim logic operation is an add operation 703C, the download manager 134 applies any bit masking information of the identified index entry (e.g., bit masking information 1 of index i1) and subtracts the trim update value from the read trim value in the target VM location of the memory device (e.g., target VM location 542 of FIG. 5).

In operation 704, the download manager 134 checks the index to determine if a termination value of the index (e.g., index value i_{N} in the example shown in FIG. 7) has been reached. If, in operation 704 the download manager 134 determines that a termination value of the index (i.e., a last entry in the index (e.g., i_{N})) has not been reached, the trim data download process proceeds to operation 705. In operation 705, the download manager 134 increments a counter associated with the data input index and returns to operation 701 to identify the next index value (e.g., i₂) and performs operation 702 and 703 corresponding to the next index value. Operations 701-705 are repeated for each index value (e.g., index i₁ to index i_{N}) to download the trim update data (e.g., trim data 502 of FIG. 5) of the data input to the target VM location (e.g. target VM location 542 of FIG. 5). According to embodiments, if the termination value (index i_{N}) is reached in operation 704, the download process 700 proceeds to operation 706 and the trim data download process ends. According to embodiments, the first trim data download process 700 is executed by the download manager 134 at power up of the memory device (i.e., during an initialization stage of the memory device).

FIG. 8 illustrates an example of a firmware update data download process 800 of the second stage of the multi-stage data download process, executed by a download manager 134 of a memory sub-system, to download firmware update data to a target VM location (e.g., target VM location 542 of FIG. 5), according to an embodiment of the present disclosure. In an embodiment, the firmware update data (e.g., firmware codes corresponding to a full firmware update or a partial firmware update). In an embodiment, the firmware update data includes one or more firmware codes advanced trim override data includes an index associated with a data input, where each index value may include a trim target address, a trim bits masking value, a trim logical operation to be executed, and a trim change value.

At operation 801, the download manager 134 identifies firmware update data stored in a portion (e.g., second block portion or third block portion) of a programmable ROM (e.g., programmable ROM 538) and determines if the firmware update data represents a full REM update (e.g., a full REM profile corresponding to a full firmware update or override) or a partial REM update (e.g., a partial REM profile corresponding to a partial firmware update or override).

At operation 802-A, in response to identifying a full firmware update data profile (e.g., firmware update data stored in a second block portion of the programmable ROM 538 of FIG. 5), the download manager 134 executes a full firmware update data read and transfer of the full firmware update data to a target VM location of the memory device (e.g., target VM location 542 of FIG. 5).

At operation 802-B, in response to identifying a partial firmware update data profile (e.g., firmware update data stored in a third block portion of the programmable ROM 538 of FIG. 5), the download manager 134 executes a partial firmware update data read to an identified section (i.e., a specific location) of the firmware update data storage location of the target VM location in the memory device and transfer of the partial firmware update data to the identified firmware update data storage location of the target VM location of the memory device (e.g., target VM location 542 of FIG. 5).

At operation 803, the download manager 134 executes an activation of the new firmware update data (e.g., an execution of the full firmware update or the partial firmware update). According to embodiments, the first trim data download process 800 is executed by the download manager 134 at power up of the memory device (i.e., during an initialization stage of the memory device).

According to embodiments, at the completion of the download process shown in FIG. 6, the trim update data stored in the programmable ROM (e.g., programmable ROM 538 of FIG. 5) to the target VM location (e.g., stored in the target VM location 542 as the trim data 502 of the downloaded data of FIG. 5).

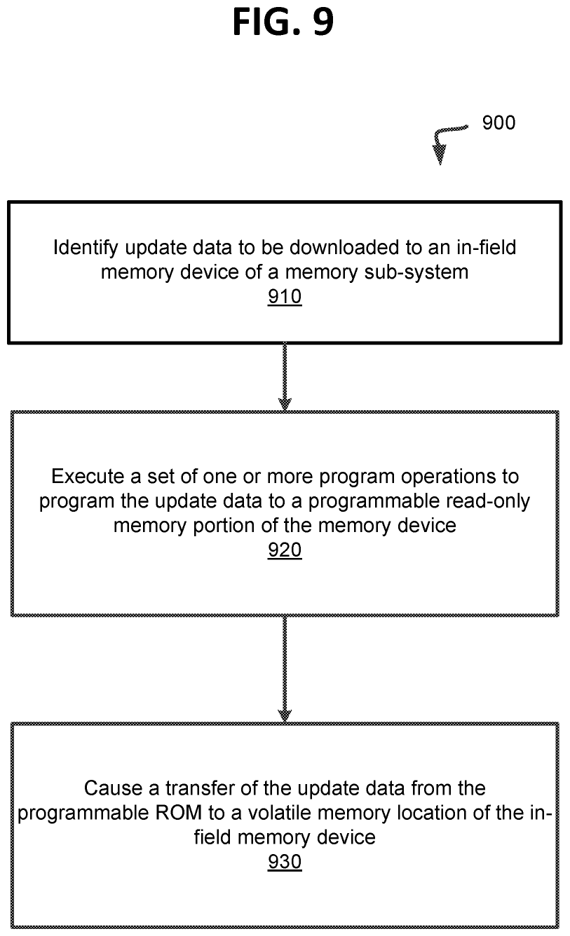

FIG. 9 is a flow diagram of an example method 900 to execute a multi-stage download process to download update data (e.g., one or more of trim update data or firmware update data) associated with a memory device in a memory sub-system in accordance with some embodiments of the present disclosure. The method 900 is described with reference to FIGS. 1A-8. The method 900 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 900 is performed by download manager 134 of FIGS. 1A, 1B and 4-8. According to embodiments, portions of the control logic of the download manager 134 may be located in the memory sub-system controller (e.g., memory sub-system controller 115 of FIGS. 1A and 1B) and the local media controller (e.g., local media controller 135 of FIGS. 1A and 1B). Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 910, data is identified. For example, control logic (e.g., download manager 134) can identify update data to be downloaded to an in-field memory device of a memory sub-system (i.e., a memory device that is in a runtime environment). In an embodiment, the update data includes trim update data (e.g., as shown in FIG. 4), REM update data (e.g., firmware update data as shown in FIG. 4), or both. According to embodiments, the update data is provided by a source (e.g., a memory device vendor) via an interface (e.g., in-field programming interface 501 of FIG. 5). In an example, the interface is an OTP-like in-field programming interface.

At operation 920, an operation is performed. For example, control logic executes a set of one or more program operations to program the update data to a programmable read-only memory (ROM) portion of the memory device. In an embodiment, the update data includes trim update data. According to embodiments, the time update data may include a first type of trim update data (as described with reference to FIG. 6), a second type of trim update data (as described with reference to FIG. 7), or both. According to embodiments, the update data may include REM update data (e.g., a full REM update or a partial REM update). According to embodiments, the control logic identifies a portion of the programmable ROM based on the type of update data included in the data input received via the interface. In an embodiment, the control logic identifies a first portion of the programmable ROM allocated or designated for storing trim update data, a second portion of the programmable ROM allocated or designated for storing full REM update data (e.g., a full firmware update), or a third portion of the programmable ROM allocated or designated for storing partial REM update data (e.g., a partial firmware update).

At operation 930, a transfer is caused. For example, control logic causes a transfer of the update data from the programmable ROM to a volatile memory location of the in-field memory device. In an embodiment, the volatile memory location is target VM location 542 of FIG. 5. In an embodiment, the transfer of the update data is initiated at power up of the memory device (e.g., during a memory device initialization stage). In an embodiment, at power up of the memory device, control logic checks a first block portion of the programmable ROM to determine if trim update data is stored therein, and if so, causes the transfer of the trim update data to the volatile memory of the memory device. In an embodiment, at power up of the memory device, control logic checks a second block portion of the programmable ROM to determine if a full REM update data is stored therein, and if so, causes the transfer of the full REM update data to the volatile memory of the memory device. In an embodiment, at power up of the memory device, control logic checks a second block portion of the programmable ROM to determine if a partial REM update data is stored therein, and if so, causes the transfer of the partial REM update data to the volatile memory of the memory device.

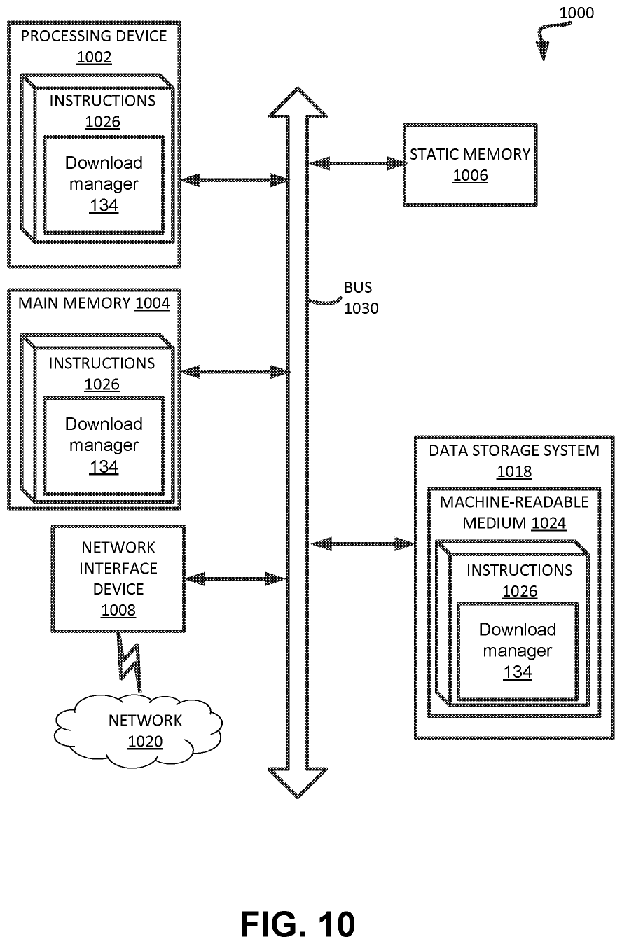

FIG. 10 illustrates an example machine of a computer system 1000 within which a set of instructions, for causing the machine to perform any one or more of the methodologies discussed herein, can be executed. In some embodiments, the computer system 1000 can correspond to a host system (e.g., the host system 120 of FIG. 1A) that includes, is coupled to, or utilizes a memory sub-system (e.g., the memory sub-system 110 of FIG. 1A) or can be used to perform the operations of a controller (e.g., to execute an operating system to perform operations corresponding to download manager 134 of FIGS. 1A and 1B). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1000 includes a processing device 1002, a main memory 1004 (e.g., read-only memory (ROM), flash memory, dynamic random access memory (DRAM) such as synchronous DRAM (SDRAM) or Rambus DRAM (RDRAM), etc.), a static memory 1006 (e.g., flash memory, static random access memory (SRAM), etc.), and a data storage system 1018, which communicate with each other via a bus 1030.

Processing device 1002 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 1002 can also be one or more special-purpose processing devices such as an application specific integrated circuit (ASIC), a field programmable gate array (FPGA), a digital signal processor (DSP), network processor, or the like. The processing device 1002 is configured to execute instructions 1026 for performing the operations and steps discussed herein. The computer system 1000 can further include a network interface device 1008 to communicate over the network 1020.

The data storage system 1018 can include a machine-readable storage medium 1024 (also known as a computer-readable medium, such as a non-transitory computer-readable medium) on which is stored one or more sets of instructions 1026 or software embodying any one or more of the methodologies or functions described herein. The instructions 1026 can also reside, completely or at least partially, within the main memory 1004 and/or within the processing device 1002 during execution thereof by the computer system 1000, the main memory 1004 and the processing device 1002 also constituting machine-readable storage media. The machine-readable storage medium 1024, data storage system 1018, and/or main memory 1004 can correspond to the memory sub-system 110 of FIG. 1A.

In one embodiment, the instructions 1026 include instructions to implement functionality corresponding to download manager 134 of FIGS. 1A and 1B). While the machine-readable storage medium 1024 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A memory device comprising:
a programmable read only memory (ROM) block comprising a first portion, a second portion, and a third portion;
a volatile memory location; and
control logic coupled to the programmable ROM and the volatile memory location, to perform operations comprising:
causing a transfer of update data stored in a portion of the programmable ROM to the volatile memory location, wherein the update data is received from a source when the memory device is operating in an in-field environment.

2. The memory device of claim 1, the operations further comprising in response to a power up of the memory device, identifying the update data stored in the first portion of the programmable ROM, wherein the update data comprises trim update data.

3. The memory device of claim 1, the operations further comprising identifying, in response to a power up of the memory device, the update data stored in the second portion of the programmable ROM, wherein the update data comprises a full firmware update.

4. The memory device of claim 3, the operations further comprising activating the full firmware update.

5. The memory device of claim 1, the operations further comprising identifying, in response to a power up of the memory device, the update data stored in the third portion of the programmable ROM, wherein the update data comprises a partial firmware update.

6. The memory device of claim 5, the operations further comprising activating the partial firmware update.

7. The memory device of claim 1, wherein the update data is received from a source via an interface coupled to memory sub-system controller coupled to the memory device.

8. The memory device of claim 1, wherein the volatile memory location comprises a static random access memory.

9. A method comprising:
identifying update data stored in a portion of a programmable read only memory (ROM) of a memory device operating in an in-field environment; and
causing a transfer of the update data from the programmable ROM to a volatile memory location of the memory device.

10. The method of claim 9, further comprising identifying the update data received from a source external to the memory device via an interface.

11. The method of claim 10, further comprising:
determining a type of the update data; and
executing a set of one or more program operations to program the update data to one of a first portion, a second portion, or a third portion of the programmable ROM based on the type of the update data.

12. The method of claim 11, wherein the type of update data comprises trim update data.

13. The method of claim 12, wherein the trim update data is programmed to the first portion of the programmable ROM designated to store the trim update data.

14. The method of claim 11, wherein the type of update data comprises a full firmware update.

15. The method of claim 14, wherein the full firmware update is programmed to the second portion of the programmable ROM designated to store the full firmware update.

16. The method of claim 14, further comprising activating the full firmware update.

17. The method of claim 11, wherein the type of update data comprises a partial firmware update; and wherein the partial firmware update is programmed to the third portion of the programmable ROM designated to store the partial firmware update.

18. The method of claim 17, further comprising activating the partial firmware update.

19. The method of claim 9, wherein the transfer of the update data from the programmable ROM to the volatile memory location is initiated in response to a power up of the memory device.

20. A memory device comprising:
a programmable read only memory (ROM) block comprising a first portion, a second portion, and a third portion;
a volatile memory location; and
control logic coupled to the programmable ROM and the volatile memory location, to perform operations comprising:
identifying update data stored in a portion of the programmable ROM of the memory device operating in an in-field environment; and
in response to a power up of the memory device operating in the in-field environment, causing a transfer of the update data from the programmable ROM to the volatile memory location of the memory device.
